(19) United States
(12) Patent Application Publication
(10) Pub. No.: US 2010/0266206 A1
(43) Pub. Date: Oct. 21, 2010

(54) METHOD AND COMPUTER-READABLE RECORDING MEDIUM FOR ADJUSTING POSE AT THE TIME OF TAKING PHOTOS OF HIMSELF OR HERSELF

(75) Inventors: Hyungeun Jo, Daejeon (KR); Jung-hee Ryu, Seoul (KR)

Correspondence Address: HUSCH BLACKWELL SANDERS LLP, 190 Carondelet Plaza, Suite 600, ST. LOUIS, MO, 63105, US

(73) Assignee: OLAWORKS, INC., Seoul (KR)

(21) Appl. No.: 12/741,824

(22) PCT Filed: Nov. 3, 2008
(86) PCT No.: PCT/KR2008/006472

§ 371 Date: May 6, 2010

(30) Foreign Application Priority Data
Nov. 13, 2007 (KR) 10-2007-0115351

(51) Int. Cl. G06K 9/46

(52) U.S. Cl. 382/190

(57) ABSTRACT

A method for helping a user to create digital data by informing if at least one face is fully included in a frame which is a predetermined area in a screen of a digital apparatus, includes the steps of: detecting the face and tracking the detected face during a preview state in which the face is displayed on the screen of the digital apparatus; testing whether the whole area of the detected face is placed in the frame of the screen or not; and providing feedback to the user that at least part of the whole area of the detected face is not placed in the frame of the screen until the whole area of the face is encompassed in the frame. It may help the user to take the photographs of himself or herself easily at the pose the user wants to take.

### TECHNICAL FIELD

The present invention relates to a method for adjusting a pose of a user at the time of taking self-portrait photographs; and, more particularly, to the method for helping the user to take the photographs of himself or herself easily at the pose the user wants to take even at the time of taking self-portrait photographs by applying face detection technology and face tracking technology during a preview state which is displayed through a screen of a digital device such as a camera before creating digital data by pressing a shutter of the digital device to recognize the pose and checking whether or not the whole face is in the photo frame by referring to the recognized pose or whether or not the angle or location of a face is identical to that of a template selected before taking a photograph and then notifying the proper angle or location to the user in real time.

### BACKGROUND ART

Thanks to the wide spread of digital apparatuses exclusively for photography such as cameras, mobile phones and PC cameras as well as digital devices such as mobile terminals and mp3 players imbedding apparatuses for taking photographs, the number of users who use such devices has largely increased.

### DISCLOSURE OF INVENTION

### Technical Problem

However, when a user takes self-portrait photographs by using a variety of apparatuses such as cameras, the user may have to take photographs repeatedly while checking the pose that s/he wants to take until s/he satisfies the pose or the user may need additional devices such as separate LCD display or convex lens to the same direction as the lens of the camera device to see his or her own image at the time of taking photographs.

### Technical Solution

In order to solve the problem of the conventional technology, it is an object of the present invention to give a user feedback to make his or her whole face included in a photo frame without repeatedly taking photos or adding more devices and to make the user take self-portrait photos easily at the pose that the user intends to take by detecting and tracking a face during a preview state of a digital device such as camera, mobile phone or PC camera.

Furthermore, it is another object of the present invention to accurately detect the motion of the user; to check if the angle of pose of the face is same to that of the template selected before taking a photograph and then provide feedback to the user by detecting and tracking a face of the user during the preview state of such digital apparatus, to thereby have the user take self-portrait photographs easily while maintaining the angle of pose of the face the user intends to do.

### ADVANTAGEOUS EFFECTS

In accordance with the present invention, it is possible to remove the trouble of checking the composition of each taken picture while repeatedly taking photographs until a user gets the picture at the composition the user desires and to easily take self-portrait photos at the desirable composition which the full image of the user's face is included in a certain frame without installing additional devices such as separate LCD display or convex lens to the same direction as the lens of a camera device.

In addition, the present invention helps the user to detect and track a face during the preview state of a digital apparatus such as camera, mobile phone or PC camera and provide feedback regarding whether or not the face angle is identical to that in the template selected by the user in real time and thus to take self-portrait photos easily at the face angle or the location the user wants.

### BRIEF DESCRIPTION OF THE DRAWINGS

The above objects and features of the present invention will become more apparent from the following description of the preferred embodiments given in conjunction with the accompanying drawings, in which:

FIG. 1 is a diagram of the whole system 100 for helping a user who uses a digital apparatus such as camera, mobile phone or PC camera to take self-portrait photos in accordance with the present invention.

FIG. 2 is a drawing illustrating an example of easily testing whether all parts of a face are included in a photo frame or not by using face detection and tracking technology.

FIG. 3 is a drawing showing an example of the user taking self-portrait photos so as to include the faces of all persons in the photo frame by using the system in accordance with an example embodiment of the present invention.

FIG. 4 is a drawing illustrating the example of checking whether the angle of pose of a face is identical to that of the template selected by the user by using the face detection and tracking technology.

FIG. 5 is a diagram showing an example of the user taking self-portrait photos by setting the angle of pose of a face is identical to that of the template selected in accordance with an example embodiment of the present invention.

### BEST MODE FOR CARRYING OUT THE INVENTION

The configurations of the present invention for accomplishing the above objects of the present invention are as follows.

In one aspect of the present invention, there is provided a method for helping a user to create digital data s/he wants by informing if at least one face is fully included in a frame which is a predetermined area in a screen of a digital apparatus at the time of taking a photo of the face of at least one person with the digital apparatus, including the steps of: (a) detecting the face by using a face detection technology and tracking the detected face by using a face tracking technology during a preview state in which the face is displayed on the screen of the digital apparatus; (b) testing whether the whole area of the detected face is placed in the frame of the screen or not; and (c) providing feedback to the user that at least part of the whole area of the detected face is not placed in the frame of the screen until the whole area of the face is encompassed in the frame.

In another aspect of the present invention, there is provided a method of helping a user to create digital data regarding at least one person whose face is arranged at a specific angle or location the user wants to take at the time of taking a photo of the person by using a digital apparatus, including the steps of: (a) selecting a specific template among at least one template which includes information on the angles or locations of faces; (b) detecting the face of the person by using a face detection technology during a preview state in which the face is displayed on a screen of the digital apparatus; (c) testing whether the angle or location of the detected face is consistent with the specific angle or location of a face included in the specific template or not; and (d) providing feedback to the user that the angle or location of the detected face is not identical to the specific angle or location until they become identical with each other.

### MODE FOR THE INVENTION

In the following detailed description, reference is made to the accompanying drawings that show, by way of illustration, specific embodiments in which the present invention may be practiced. These embodiments are described in sufficient detail to enable those skilled in the art to practice the present invention. It is to be understood that the various embodiments of the present invention, although different from one another, are not necessarily mutually exclusive. For example, a particular feature, structure, or characteristic described herein in connection with one embodiment may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The embodiments of the present invention will be described, in detail, with reference to the accompanying drawings.

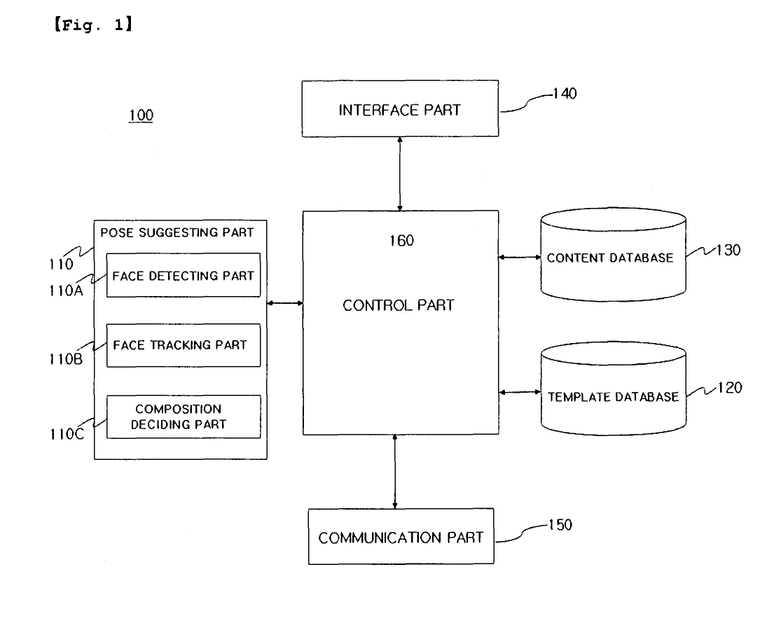

FIG. 1 is a diagram of a whole system 100 for taking a self-portrait photo at a desirable composition a user intends by using a digital apparatus such as camera, mobile phone or PC camera in accordance with an example embodiment of the present invention.

An example that the present invention is applied mainly to a case that a still image such as photo is created will be explained, but it is sure that the present invention may be applicable to a moving picture.

By referring to FIG. 1, the whole system 100 may include a pose suggesting part 110, a template database 120, a content database 130, the interface part 140, a communication part 150, a control part 160 etc.

In accordance with the present invention, at least some of the pose suggesting part 110, the template database 120, the content database 130, the interface part 140, and the communication part 150 may be included in the user terminal such as camera or they may be the program modules capable of communicating with the user terminal (however, provided, that FIG. 1 illustrates that the pose suggesting part 110, the template database 120, the content database 130, the interface part 140, and the communication part 150 are all included in the user terminal). Such program modules may be included in the user terminal in a form of an operating system, application program modules or other program modules or may be physically recorded in a memory well-known to the public. In addition, such program modules may be recorded in a remote memory communicable with the user terminal. They include a routine, subroutine, program, object, component, data structure etc. which performs specific tasks or specific abstract data types to be described below in accordance with the present invention but they are not limited thereto.

The pose suggesting part 110 may include a face detecting part 110A, a face tracking part 110B, a composition deciding part 110C etc. Herein, the face detecting part 110A, the face tracking part 110B, and the composition deciding part 110C are classified for convenience sake to perform the function to recognize the location and angle of a face appearing in a specific frame of a screen by detecting the face, but they are not limited thereto.

The face detecting part 110A performs the role in detecting face area of at least one person included in a frame of a screen of a digital device at a preview state which is displayed through the screen before creating digital data by pressing a shutter of the digital device. Herein, the frame means a predetermined area on the screen and it may be part or whole area of the screen as the case may be.

The face tracking part 110B may frequently track the detected face area at periodic or non-periodic intervals.

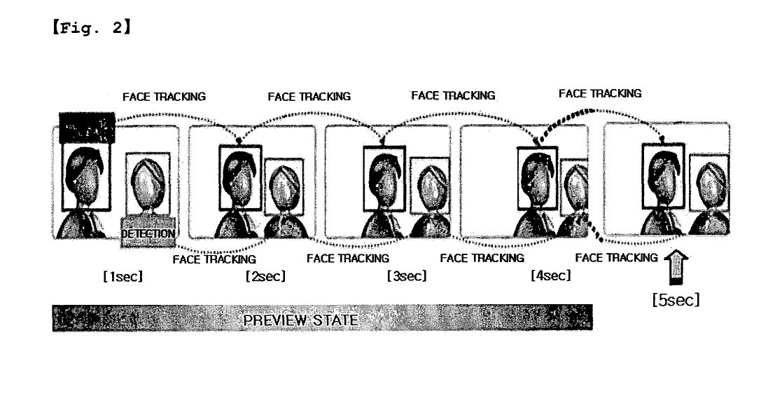

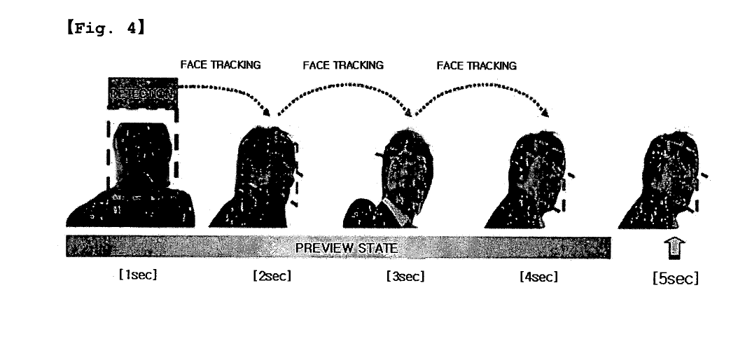

Moreover, the composition deciding part 110C may perform the role in providing feedback by judging whether the detected or tracked face area is fully included in the screen or not and may also offer feedback (e.g., voice guide, LED or display) in order to make the angle of the face identical to that of the template selected by the user. The face detection and face tracking process and the composition deciding process are explained in more detail by referring to FIGS. 2 and 4 below.

FIG. 2 is a diagram illustrating an example of how to detect and track a face.

By referring to FIG. 2, the preview state during which the state, expression, pose etc. of a subject may be observed through a screen of a digital apparatus such as camera before digital data such as photo is created with the digital apparatus.

By referring to FIG. 2, during the preview state, the detected face area is found to be tracked, e.g., per second and the digital data is created by pressing the shutter when 5 seconds elapse after the preview state starts.

Specifically, tracking the face area is made every one second after the preview state starts and it may be found that the full faces of all persons are included in the photo frame when 1, 2 and 3 seconds elapse after the preview state starts. Thereafter, at four seconds after the preview state starts, a face of one of the subject persons is located outside of the photo frame and then a digital data created by pressing the shutter at five seconds after the preview state starts is considered as the case in which the faces of all the persons are included in the photo frame.

As shown in FIG. 2, the composition deciding part 110C may check whether the tracked face area is fully included in the screen whenever tracking is performed during the preview state, and may give feedback in the forms of voice guide etc. that the face of one person is out of the photo frame at four seconds.

As the technology applied to the face detecting part 110A, the technology related to face matching to compare feature data regarding eye area among the areas of all parts of the face may be considered, and more specifically, “Lucas-Kanade 20 Years On: A Unifying Framework,” an article authored by Baker, S and one other and published in the International Journal of Computer Vision (IJCV) in 2004 is an example. The article mentions how to effectively detect the location of eyes from the image which includes the face of a person by using a template matching method. The technology applicable to the face detecting part 110A in the present invention is not limited to the article but it is exemplarily described.

The face detecting part 110A may assume the locations of a nose and a mouth based on the location of detected eyes by the above-mentioned technology and each part of the face is tracked periodically or non-periodically by the face tracking part 110B. In addition, the composition deciding part 110C may determine whether the full areas of the face are included in the photo frame by referring to each part of the detected and tracked face.

Like the method for searching a face, the method for searching each part such as eyes, nose and mouth may be executed by using technology such as linear discrimination analysis disclosed in Eigenfaces vs. Fisherfaces: Recognition Using Class Specific Linear Projection,” an article authored by P. N. Belhumeur and two others and published in IEEE TRANSACTIONS ON PATTERN ALAYSIS AND MACHINE INTELLIGENCE in 1997.

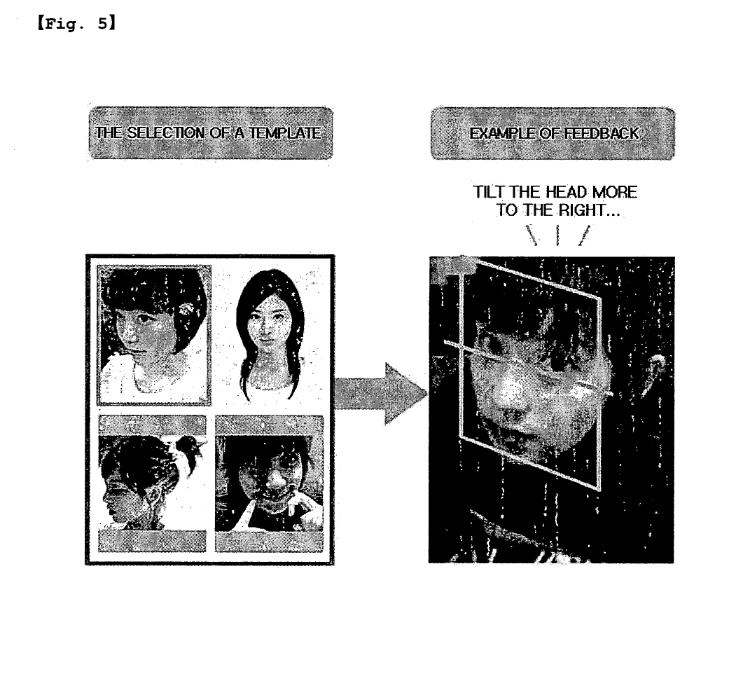

The template database 120 may record templates regarding digital data such as photos of which the faces of a variety of persons are taken and may allow the user to take self-portrait photos at a specific angle identical to an angle included in a template selected among the templates recorded in the template database 120. This will be explained in more detail by referring to FIGS. 4 and 5.

Digital data photographed in the past may be recorded in the content database 130.

A variety of databases such as the template database 120 and the content database 130 mentioned in the present invention may include databases not only in a narrow meaning but also in a wide meaning including data logs based on file systems, and they may be included in the system 100, but also may exist in a remote memory communicable to the system 100.

The interface part 140 may show the preview state and the state of the images created by pressing the shutter through the monitor of the digital apparatus.

The communication part 150 is responsible for transmitting and receiving the signal among the modules included in the system 100 or transmitting and receiving data with a variety of external devices.

In accordance with the present invention, the control part 160 performs a function to control the data flow among the pose suggesting part 110, the template database 120, the content database 130, the interface part 140 and the communication part 150. In other words, the control part 160 in accordance with the present invention controls the pose suggesting part 110, the template database 120, the content database 130 and the interface part 140 to execute their unique functions by controlling the signals transmitted and received among the modules through the communication part 150.

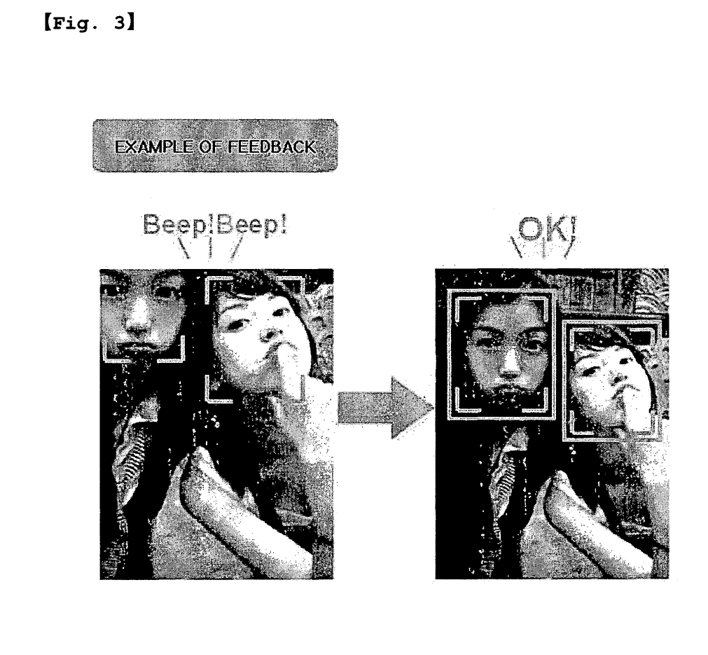

FIG. 3 is a drawing showing an example of notifying whether a face is included in the photo frame during self-portrait shooting or not in real time in accordance with an example embodiment of the present invention.

While detecting the face(s) periodically or non-periodically and tracking them frequently at the preview state for taking a still image (or a moving picture), the digital apparatus such as camera may check whether the faces appear in a specific frame included in the screen of the terminal or not and notify the result by using, e.g., a sound, a light-emitting diode (LED) or a display.

In FIG. 3, if “O.K.” signal sound is beeped, the user may take the photo of full images of the faces of all the persons by pressing the shutter. However, it is not limited to this and if the faces are in the frame, it may be set to take photos automatically.

FIG. 4 is a drawing illustrating an example of how to detect and track a face to take a photo at a specific angle of pose of a face identical to that of the model included in the template selected by the user.

The diagram exemplarily shows that the face tracking part 110B performs tracking every second regarding the face areas detected by the face detecting part 110A during the preview state and digital data is created by pressing the shutter at five seconds after the preview state starts.

In the concrete, the face areas are tracked every second, i.e., at one, two, three and four seconds after the preview state starts. It is found that the back view of the subject at one second, the side face less turned at two seconds, the side face more turned at three seconds and the side face less turned again at four seconds are shown on the screen. Assuming that the user presses the shutter and the side face is shot at five seconds. As such, it is possible to see that the face detecting part 110A and the face tracking part 110B catches the angle of pose of the face displayed on the screen at the preview state while detecting and tracking the face areas. The information on the angle and location of such face may be obtained by grasping the relative location and size of each part of the face which is being tracked. Herein, each part of the face may include at least one of eyes, a nose or a mouth.

The composition deciding part 110C compares the angle and location of pose of the face during the preview state grasped through the process of FIG. 4 with that of the face of the model included in the template selected by the user. The example of selection of such template and its application will be additionally explained by referring to FIG. 5.

FIG. 5 is a diagram showing a concrete example of helping the user to easily take self-portrait photos at a specific angle and/or location of his/her face identical to that of the face of the model included in the template selected by the user in accordance with an example embodiment of the present invention.

By referring to the left region of FIG. 5, it illustrates the case that the user interface is provided to enable the user to select a template the user wants to use and the template on the top of the left is selected.

While detecting and tracking the face of the subject periodically or non-periodically during the preview state as shown in FIG. 4, the composition deciding part 110C compares the angle and/or location of the face of the subject with that of the face included in the selected template and provides feedback to the user by referring to the result of comparison. For example, if the composition deciding part 110C decides that the angle of the face of the user is different from that of the person included in the template selected by the user, it may allow the user to take self-portrait photographs with a specific desired angle of his or her own face by providing the feedback through the audible signal such as “tilt the head more to the right . . . ” (to adjust the plane on which each area of the face is located three-dimensionally, i.e., out-of-plane) or “turn the head more clockwise . . . ” (to adjust the plane on which each area of the face is located two-dimensionally, i.e., in-plane) or LED signal or a monitor (on which the face and location guide for the face are displayed in case front view camera/rotary camera is used) through the interface part 140 etc. But this is not limited to it, but it may allow photos to be taken automatically if an angle of a face meets a template condition.

Self-portrait shooting has been explained, but it is not limited to this and even in case the user of the digital apparatus takes photos of others, it may be performed in a similar way.

The embodiments of the present invention can be implemented in a form of executable program command through a variety of computer means recordable to computer readable media. The computer readable media may include solely or in combination, program commands, data files and data structures. The program commands recorded to the media may be components specially designed for the present invention or may be usable to a skilled person in a field of computer software. Computer readable record media include magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

While the invention has been shown and described with respect to the preferred embodiments, it will be understood by those skilled in the art that various changes and modification may be made without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

1. A method for determining the presence of a face from image data within a frame in taking a picture, the method comprising the steps of:
detecting a human face of a person included in an image by using a face detection technology that identifies an image likely to contain a human face, the image being collected with a digital apparatus;
tracking the detected face by using a face tracking technology during a preview state in which the face is displayed on a screen of the digital apparatus;
continually determining if the entire image area of the detected face remains within a frame of the screen; and
providing feedback to the user of the determination to inform the user that at least a portion of the entire image area of the detected face does not remain within the frame of the screen until the entire image area of the face is encompassed within the frame.

2. The method of claim 1, wherein tracking is performed by using the digital apparatus until digital data is created.

3. The method of claim 1, wherein the digital data is a still image or a moving picture.

4. The method of claim 1, wherein the step of continually determining includes the step of testing whether the entire image area of the tracked face is encompassed in the frame or not.

5. The method of claim 4, wherein the step of providing feedback to the user includes the step of creating digital data automatically if the entire image area of the tracked face is encompassed in the frame.

6. The method of claim 5, wherein the step of providing feedback to the user includes the step of providing feedback to the user that at least a portion of the entire image area of the tracked face does not remain within the frame of the screen until the entire image area of the face is encompassed within the frame.

7. The method of claim 1, wherein the feedback is provided via at least one of means selected from the group consisting of sound, a light-emitting diode (LED), or a screen.

8. The method of claim 1, wherein the person includes the user.

9. A method for assisting a user to take a digital picture of at least one human face with a user-desired angle or position, the method comprising the steps of:
(a) selecting a user-desired template among at least one template which includes information on angles or locations of human faces within a frame of a screen of a digital apparatus;
(b) detecting a human face of a person included in an image by using a face detection technology during a preview state in which the face is displayed on the screen of the digital apparatus, the image being collected with the digital apparatus;
(c) continually determining if an angle or location of the detected face matches with the angle or location of a face included in the selected template; and
(d) providing feedback to the user of the determination to inform the user that the angle or location of the detected face does not match with the angle or location of the selected template until the angle or location of the detected face matches with the angle or location of the selected template.

10. The method of claim 9, wherein the step (b) includes the step of tracking the detected face by using a face tracking technology during the preview state.

11. The method of claim 10, wherein tracking is performed by using the digital apparatus until digital data is created.

12. The method of claim 10, wherein the digital data is a still image or a moving picture.

13. The method of claim 10, wherein the step (c) includes the step of testing whether the angle or location of the tracked face is identical to the angle or location included in the selected template.

14. The method of claim 13, wherein the step (d) includes the step of creating digital data automatically when the angle or location of the tracked face is identical to the angle or location included in the selected template.

15. The method of claim 14, wherein the step (d) includes the step of providing the feedback to the user that the angle or location of the tracked face is not identical to the angle or location included in the selected template until they become identical with each other.

16. The method of claim 15, wherein the angle includes information on the case in which an angle is adjusted by adjusting the plane where each part of the face is located three-dimensionally (out-of-plane) and information on the case in which an angle is adjusted two-dimensionally on the plane where each part of the face is located (in-plane).

17. The method of claim 9, wherein the feedback is provided via at least one selected from the group consisting of sound, a light-emitting diode (LED), or a screen.

18. The method of claim 9, wherein the person includes the user.

19. The method of claim 9, wherein the template is provided through the screen of the digital apparatus.

20. The method of claim 19, wherein the information on the angle or location included in the template is obtained by grasping the location and size of each part of the face in the template.

21. The method of claim 20, wherein each part of the face includes at least one of eyes, nose or mouth.

22. One or more computer-readable media having stored thereon a computer program that, when executed by one or more processors, causes the one or more processors to perform acts including:
detecting a human face included in an image by using a face detection technology that identifies an image likely to contain a human face, the image being collected with a digital apparatus;
tracking the detected face by using a face tracking technology during a preview state in which the face is displayed on a screen of the digital apparatus;
continually determining if the entire image area of the detected face remains within a frame of the screen; and
providing feedback to the user of the determination to inform the user that at least a portion of the entire image area of the detected face does not remain within the frame of the screen until the entire image area of the face is encompassed within the frame.
